(19) United States
(12) Patent Application Publication
(10) Pub. No.: US 2010/0273137 A1
(43) Pub. Date: Oct. 28, 2010

(54) TIME TEACHING AIDS AND METHODS

(76) Inventors: Halloween Carter, Rancho Santa Fe, CA (US); Kimberly A. Gerber, Calabasas, CA (US)

Correspondence Address: DUCKOR SPRADLING METZGER & WYNNE;A LAW CORPORATION, 3043 4th Ave., SAN DIEGO, CA, 92103, US

(21) Appl. No.: 12/431,327

(22) Filed: Apr. 28, 2009

(51) Int. Cl. G09B 19/12

(52) U.S. Cl. 434/304

(57) ABSTRACT

An aid for teaching the concept of time to children and others may include a working analog clock and a manipulative analog clock having features substantially identical to the working analog clock. The working analog clock may be used alone or in conjunction with the manipulative analog clock. Both clocks each include distinctive non-numerical elements such as distinctive wedge sections representing five minute intervals and distinctive hour and minute hands. The manipulative clock may be used by the child or other user by manually moving one or both of the hands to certain ones of the wedge sections such as a section representing the time of the completion of a desired time interval. At the end of the desired time interval or duration, the corresponding hand on the working clock will be disposed at the corresponding certain one of the wedge sections on the manipulative clock. Thus, the user learns more readily by being involved in setting the manipulative clock himself or herself, and also will know when the end of the interval occurs, thereby more readily learning time intervals.

### BACKGROUND OF THE INVENTION

1. Field of the Invention

The present invention relates in general to time teaching aids. It more particularly relates to time teaching aids and methods of teaching time intervals and durations to children and others desiring to learn the concepts of time intervals or durations.

2. Background Art

There is no admission that the background art disclosed in this section legally constitutes prior art.

It is quite common for parents and others to encounter the difficulties children may have in understanding the concept of time intervals. For example, children may ask “are we there yet?” from the back seat of the automobile, waiting for someone special to arrive or the end of an expected period of time, or others. Young children may know their numbers, but have not yet reached the state of understanding the numerical differences of numbers relating to time durations. Therefore, guidance may be provided to the child to read and to understand the functioning of a clock. For example, there have been a variety of time teaching aids including colors or images to assist in teaching a child to tell the time when looking at a clock. Reference may be made to the following U.S. Pat. Nos. 2,567,497; 3,608,214; 3,967,389; 4,124,945; 7,394,725, Des. 146,757; and Des. 149,106.

In an attempt to teach the concept of time intervals, several aids including timers have been proposed to demonstrate a waiting time or a duration of time for an activity for the child or others. For example, reference may be made to the following U.S. Pat. Nos. 5,044,961; 5,646,913; 5,662,479; 6,416,216; and 7,414,923.

### BRIEF DESCRIPTION OF THE DRAWINGS

The features of this invention and the manner of attaining them will become apparent, and the invention itself will be best understood by reference to the following description of certain embodiments of the invention taken in conjunction with the accompanying drawings, wherein:

FIG. 1 is a face view of an embodiment of a time interval teaching aid constructed according to the present invention showing a kit including a working analog clock and a manipulative clock;

FIG. 2 is a partial sectional plan view of another embodiment of a time interval teaching aid, which is also constructed according to the present invention;

FIG. 3 is a diagrammatic sectional side view of the time interval teaching aid of FIG. 2;

FIG. 4 is a block diagram of the time interval teaching aid of FIG. 2; and

FIG. 5 is a flowchart of the operation of the time interval teaching aid of FIG. 2.

### DESCRIPTION OF CERTAIN EMBODIMENTS OF THE INVENTION

It will be readily understood that the components of the embodiments as generally described and illustrated in the drawings herein, could be arranged and designed in a wide variety of different configurations. Thus, the following more detailed description of the embodiments of the system, components and method of the present invention, as represented in the drawings, is not intended to limit the scope of the invention, as claimed, but is merely representative of the embodiments of the invention.

An aid for teaching the concept of time to children and others may include a working analog clock and a manipulative analog clock having features substantially identical to the working analog clock. The working analog clock may be used alone or in conjunction with the manipulative analog clock. Both clocks each include distinctive non-numerical elements such as distinctive wedge sections representing five minute intervals and distinctive hour and minute hands. The manipulative clock may be used by the child or other user by manually moving one or both of the hands to certain ones of the wedge sections such as a section representing the time of the completion of a desired time interval. At the end of the desired time interval, the corresponding hand on the working clock will be disposed at the corresponding certain one of the wedge sections on the manipulative clock. Thus, the user learns more readily by being involved in setting the manipulative clock himself or herself, and also will know when the end of the interval occurs, thereby more readily learning time intervals.

Unlike the prior art countdown timers, the embodiments of the present invention relate to time teaching aids and methods to help teach concepts relating to the time of the day shown on a standard analog clock. A user may have difficulties relating a time interval to the movement of the hands on a clock. On a countdown timer a time interval of a specific length, such as twenty minutes, looks the same each time because the hand will travel from the twenty minute mark to zero during the countdown of this specific length time interval each time. However, on a standard analog clock the starting point of a time interval may be any one of the sixty minute marks on the clock face, such as a twenty minute time interval may start at 11:04 and end at 11:24 or may start at 7:45 and end at 8:05 for example. Therefore, the user may learn to understand the concept of time intervals relative to the movement of the hands on the clock.

According to yet another embodiment of the present invention, there is provided a method of teaching the concept of time intervals and durations to a user by employing an analog working clock having a group of distinctive wedge sections, a distinctive hour hand, a distinctive minute hand, and a manipulative clock similar to the working clock, comprising informing the user of a desired time interval; describing at least one of the hands of the working clock in terms of its distinctive image; describing a current location of the at least one of the hands of the working clock indicating a current wedge section as a starting time for the desired time interval; describing the desired time interval ending location for at least one of the hands of the working clock as being an ending wedge section as an ending time for the desired time interval; instructing the user to move manually the at least one of the hands of the manipulative clock to a manipulative clock current segment for demonstrating a time interval current location corresponding to the current segment of the working clock; instructing the user to move manually the at least one of the hands of the manipulative clock to an ending clock segment for demonstrating a time interval ending location corresponding to the ending segment of the working clock; and instructing the user to observe the at least one of the hands of the working clock to determine when the at least one of the hands of the working clock indicate the working clock ending segment corresponding to the manipulative clock ending segment to signify the end of the desired time interval.

According to an embodiment of the invention, the aid for teaching the concept of time intervals and durations to children or others may include a working analog clock including an inner face portion, an outer face portion, an hour hand, and a minute hand. The inner face portion may include twelve wedge sections. Each wedge section may include a distinctive image. The outer face portion may surround the inner face portion and include clock numbers appropriately spaced around the outer face portion. Each clock number may include a feature or element such as a distinctive color related to the distinctive image of the corresponding wedge section such as a corresponding distinctive color. The hour hand may include a first distinctive visual appearance. The minute hand may include a second distinctive visual appearance.

According to another aspect of an embodiment of the invention, the aid for teaching the concept of time intervals and durations to children or other users may include a manipulative analog clock having a substantially identical appearance as the working analog clock.

According to yet another aspect of an embodiment of the invention, the working analog clock may include a timer device and a plurality of LED's for illuminating the wedge sections selectively.

According to another embodiment of the invention, a method of teaching the concept of time intervals and durations to a child or others by using an analog clock having twelve distinctively imaged wedge sections, a distinctively imaged hour hand, and a distinctively imaged minute hand is disclosed. The method may include determining a desired time interval and informing the child of the time interval, describing at least one of the hands of the analog clock in terms of its distinctive image, describing a current location of the at least one of the hands of the analog clock in terms of one of the wedge sections, and describing a time interval ending location of the at least one of the hands of the analog clock in terms of another one of the wedge sections.

According to yet another embodiment of the invention, a method of teaching the concept of time intervals and durations to a child using an analog clock having twelve distinctively imaged wedge sections, a distinctively imaged hour hand, a distinctively imaged minute hand, a timer device, and a group of LEDs for individually illuminating each of the wedge sections is disclosed. The method may include receiving a time interval to be taught to a child or other person, receiving a start signal to begin a countdown of the time interval, turning on the LED associated with the wedge section of the current location of one of the hands, turning on the LED associated with the adjacent wedge section when one of the hands moves into the adjacent wedge section, determining an end of the countdown of the time interval, and flashing one or more of the LEDs for a predetermined period of time at the expiration of the time interval.

In accordance with the invention, the time interval teaching aid may provide an easily recognized visual indication of the passage of a certain period of time to help a child understand the concept of a time interval at a much earlier age. The time interval teaching aid may also be used to teach children the concept of time and also how to tell time. Therefore, a child may be capable of self monitoring time at a much earlier age.

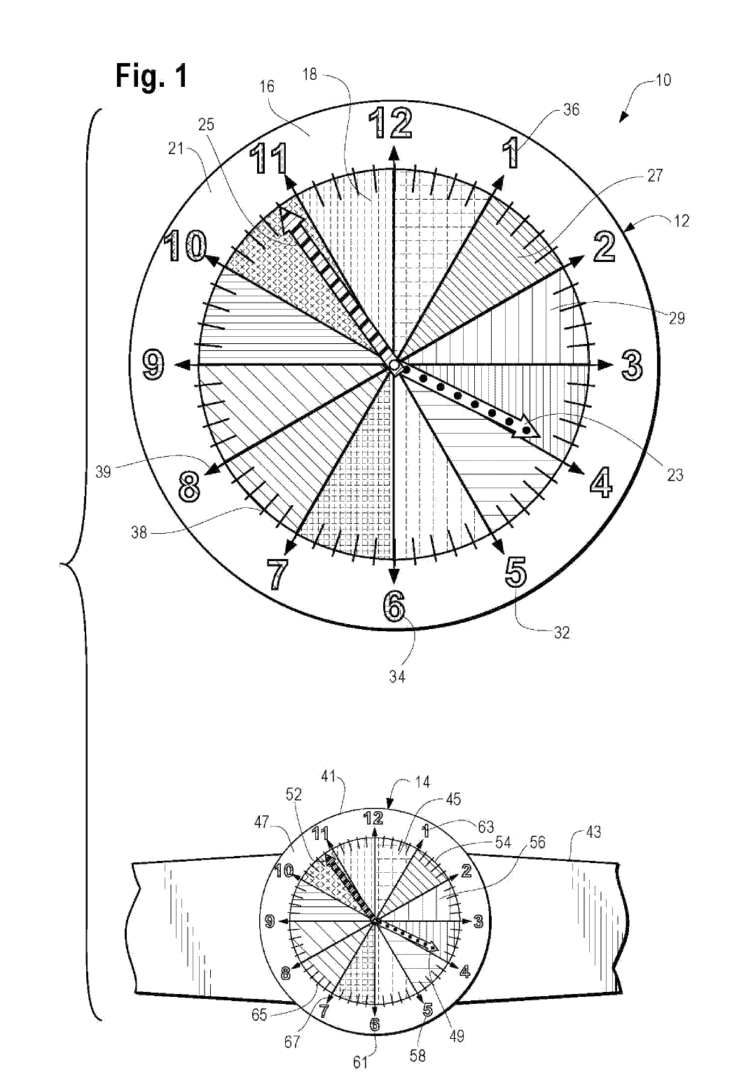

Referring to FIG. 1, an embodiment of a time interval teaching aid 10 constructed according to the present invention may include a working analog clock 12 and a similar manipulative analog clock 14, which may include many of the same features or elements as the working analog clock 12 and generally be of a similar appearance.

The working analog clock 12 may include a face 16 which may be circular in shape and which may have an inner portion 18, an outer portion 21, an hour hand 23, and a minute hand 25. The hour hand 23 and the minute hand 25 may be distinctively configured, such as with colorful dots or stripes, respectively, as shown in FIG. 1 to allow them to be easily described and recognized by a child.

The inner portion 18 of the working analog clock 12 may include a group such as twelve evenly distributed wedge sections, such as wedge sections 27 and 29, corresponding to five minute intervals of the working clock 12. Each wedge section may be colored differently to allow them to be easily described and recognized by a child.

The outer portion 21 of the working analog clock 12 may substantially surround the inner portion 18 and may include the clock numbers, such as numbers 32 and 34, evenly distributed around the outer portion 21 representing the hours of the day. Each of the clock numbers may be colored the same as a corresponding one of the wedge section, such as wedge section 27 and clock number 36, allowing the user to associate the location of the hour hand 23 of the working clock 12 with a clock number.

Dashes, such as dash 38, may be evenly distributed around the clock face 16 and extending on both the inner portion 18 and outer portion 21 of the working clock 12 representing the sixty minutes of the hour. Every fifth dash may include an arrow top, such as arrow top 39, pointing at one of the clock numbers in the outer portion 21.

The working analog clock 12 may be powered by a suitable motive device (not shown) such as a spring mechanism, a battery, an external power source, or other.

The manipulative analog clock 14 may include a face 41 which may be substantially identical to the face 16 of the working analog clock 12. The face 41 may be sized differently than the face 16 of the working analog clock 12, such as a larger face for a wall mounted demonstration clock for a classroom or may be a smaller face for a clock capable of being worn by a child.

As an option a band such as a wrist band 43 may be attached to the manipulative clock 14 to allow it to be worn by a child on his or her body such as on his or her wrist in a similar manner as a wrist watch.

The face 41 of the manipulative analog clock 14 may include an inner portion 45, an outer portion 47, an hour hand 49, and a minute hand 52. The manipulative clock hands 49 and 52 can be readily moved to different locations manually for indicating different times. In a presently preferred manner, the manipulative clock 14 may be placed on a convenient support surface such as a table (not shown) and the user can then notate the hands 49 and 52 freely to any desired position. The hour hand 47 and the minute hand 52 may be distinctively configured, such as with colorful dots or stripes, respectively, as shown in FIG. 1, to allow them to be easily described and recognized by a child or other user, and to correspond in appearance to the respective hour and minute hands of the working clock 12.

The inner portion 45 of the manipulative analog clock 14 may include a group such as twelve evenly distributed wedge sections, such as wedge sections 54 and 56, corresponding to five minute intervals of the manipulative clock 14. Each wedge section may be colored differently to allow them to be easily described and recognized by a user, and to correspond in appearance to the respective wedge sections of the working clock 12.

The outer portion 47 of the manipulative analog clock 14 may substantially surround the inner portion 45 and may include the clock numbers, such as numbers 58 and 61, evenly distributed around the outer portion 47 representing the hours of the day. Each of the clock numbers may be colored the same as a corresponding one of the wedge section, such as wedge section 54 and clock number 63, allowing the child to associate the location of the hour hand 19 of the manipulative clock 14 with a clock number.

Dashes, such as dash 65, may evenly distributed around the clock face 41 and extending on both the inner portion 45 and outer portion 47 of the manipulative clock 14 representing the sixty minutes of the hour. Every fifth dash may include an arrow top, such as arrow top 67, pointing at one of the clock numbers in the outer portion 47.

In operation, a parent or teacher may teach a child or other person about time intervals using the working analog clock 12. The parent or teacher may discuss the concept of a time interval and may describe how one of the distinctly colored hands must move from one distinctly colored wedge section to another distinctly colored wedge section before the time interval is complete. The child or other user may then observe the working clock to note the progress of the appropriate hand toward the wedge section indicating the conclusion or expiration of the time interval.

Additionally, the parent or teacher may utilize the manipulative analog clock 14 in conjunction with the working analog clock 12 to facilitate teaching the concept of time intervals to the user such as a child. The parent or teacher may instruct the user such as a child, to move the hands of the manipulative clock manually to a position at the start of the time interval (the current time indicated on the working clock). Then, the user may be instructed to move the manipulative clock hands to an ending segment to demonstrate the ending of the desired time interval. The user may then be instructed to observe how the working clock hands must move to process to the end of the time period. The hands of the manipulative clock being left at the end time segment corresponding to the ending of the desired time interval to enable the user to compare that segment with the current position of the corresponding hands of the working clock 12.

In this manner, the student can determine the ending of the desired time-interval when the working clock hands indicate the working clock ending segment corresponding to the manipulative clock ending segment indicated by its hands positioned thereat. Thus, unlike the prior art teaching aids, the user learns by doing, since the user manually moves the hands to the ending segment on the manipulative clock. Furthermore, the user will then know when the ending of the desired time interval occurs by observing the working clock and comparing the positions of the hands of the working clock and the manipulative clock, thereby more readily learning time intervals. The prior art teaching aids do not include both a working clock and a manipulative clock having a similar appearance, whereby the user can more readily learn the concept of time by comparing the manipulative clock with a similarly appearing working clock.

It should be understood that the working analog clock 12 may also include a manipulative feature, where the hands of the clock may be temporarily moved manually to demonstrate the position of the hands at the end of the time interval before being returned manually to the current time position of the hands.

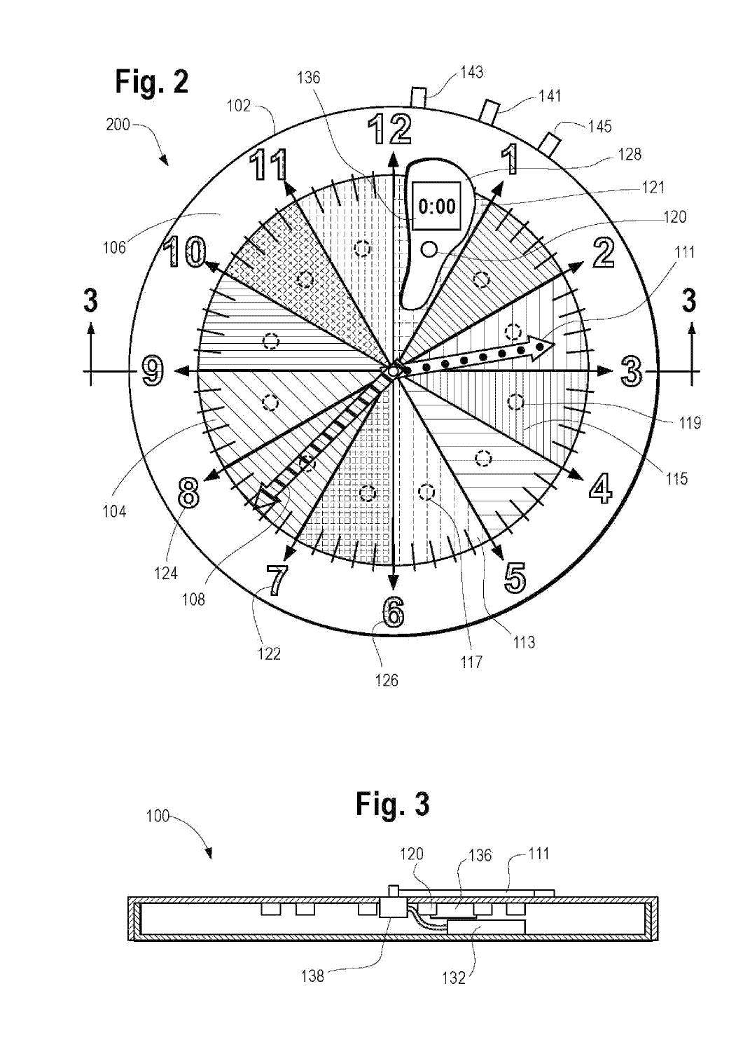

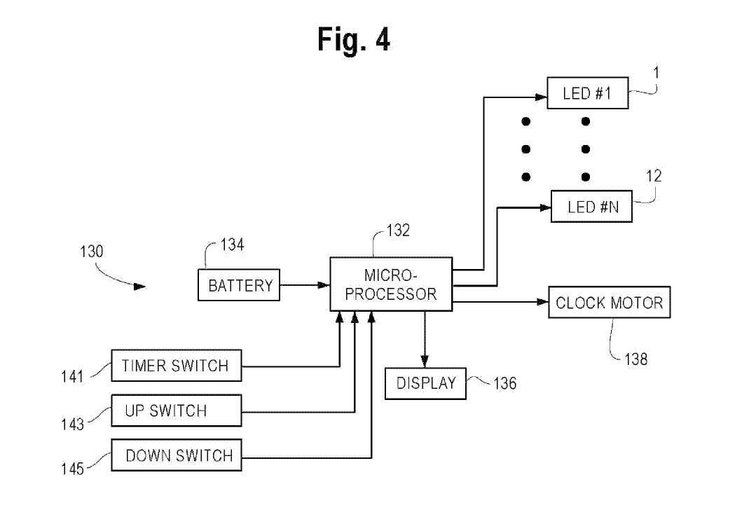

Referring now to FIGS. 2-4, another embodiment of a working analog clock 100 for use as a time interval teaching aid according to the present invention is shown. The working analog clock 100 is similar to the working analog clock 12, except that the clock 100 includes a timer device 130 and a plurality of LED's for illumination and providing attention attracting signals.

The working analog clock 100 may be used alone or in combination with a manipulative clock such as the clock 14 of FIG. 1. The clock 100 may include a face 102 having an inner portion 104, an outer portion 106, a minute hand 108, and an hour hand 111. The minute hand 108 and the hour hand 111 may be distinctively configured, such as with colorful stripes or dots, respectively, as shown in FIG. 2 to allow them to be easily described and recognized by a child or other user.

The inner portion 104 of the working analog clock 100 may include a group such as twelve evenly distributed wedge sections, such as wedge sections 113 and 115, corresponding to five minute intervals of the working clock 100. Each wedge section may be a differently colored piece of transparent material such as plastic to allow them to be easily described and recognized by the user. Beneath each of the transparent wedge sections may be an LED to illuminate that wedge section, such as LED 119 beneath or in back of wedge section 115 and LED 120 beneath or in back of wedge section 121. When illuminated, the LEDs back light selectively individual ones of the sections.

The outer portion 106 of the working analog clock 100 may substantially surround the inner portion 104 and may include the clock numbers, such as numbers 122 and 124, evenly distributed around the outer portion 106 representing the hours of the day. Each of the clock numbers may be colored the same as a corresponding one of the wedge sections, such as wedge section 113 and clock number 126, allowing the child to associate the location of the hour hand 111 of the working clock 100 with a clock number.

The timer device 130 may include a microprocessor 132 powered by a battery 134 for controlling a digital display 136, a clock motor 138 connected to the minute hand 108 and the hour hand 111, and the plurality of LED's disposed beneath the wedge sections. The display 136 may be disposed beneath the wedge section 128 and may be capable of projecting its display image through the wedge section 128 when activated to provide a countdown time image or other desired image. The microprocessor may be controlled by a timer switch 141, an up switch 143, and a down switch 145 disposed adjacent to the outer portion 106 of the working clock 100. The timer switch 141 may control activation of a timer program located in the microprocessor 132 which activates the display allowing a time interval to be set using the up switch 143 and the down switch 145. The timer device 130 may also be powered by an external power source.

The working analog device 100 may include the ability for providing an attention attracting audio alarm, such as a specific sound or tone, or actual spoken words. The working analog device 100 may also including a recording and playback device (not shown) to allow the recording and playback of personal messages at the end of time intervals.

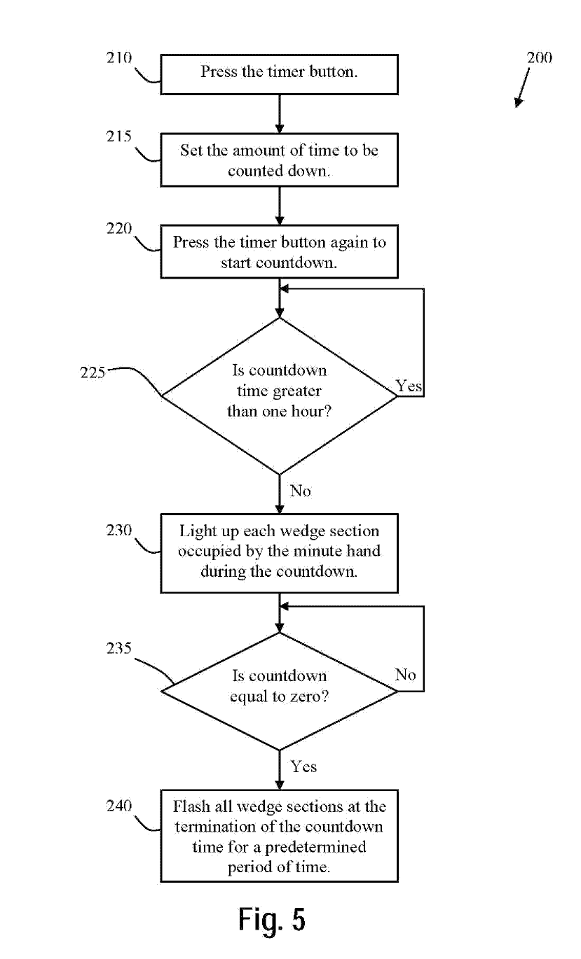

Referring now to FIG. 5, a flowchart of an embodiment of a timer program run by the microprocessor 132 is shown. The timer program 200 may be initiated by the pressing of the timer switch at step 210. The desired amount of time to be counted down may be set at step 215 by appropriately pressing the up switch and/or the down switch. At step 220 the countdown of the desired amount of time may be started by another pressing of the timer switch. The countdown time interval may then be compared to one hour. If the countdown time is greater than one hour, then the remaining countdown time may be continued to be compared to an hour. If the countdown or remaining countdown time is equal to or less than an hour, the LED located in the wedge section occupied by the minute hand may be turned on and remain on until the end of the desired period of time in step 230. The remaining countdown time in step 235 may be compared to zero. If the remaining countdown time is not equal to zero, the process may be returned to step 230. Each time the minute hand moves into a new wedge section, the LED in that section may be turned on and remain on until the end of the desired period of time in step 230. If the remaining countdown time is equal to zero corresponding to the end of the desired period of time, all of the LED's in all of the wedge sections may be flashed for a predetermined period of time in step 240.

In operation, a parent or teacher may desire to teach a child or other user about a time interval by talking to the user about the time interval and how the hands of the clock will move during the time interval. Then the parent or teacher may set the timer on the clock to the desired time interval and start the countdown for a desired time interval. When the time interval is greater than one hour, the clock may just continue to run without any visual indications until the remaining countdown time equals one hour. When the remaining countdown time equals one hour, the LED in the wedge section occupied by the minute hand may be turned on and remain on until the end of the desired time interval providing a visual indication to the user. Each time the minute hand moves into the next wedge section, the LED in that wedge section may be turned on to illuminate it and remain on until the end of the desired time interval providing another visual indication to the user. In the case where the time interval was greater than one hour, this may continue until all twelve LED's are illuminated. When the remaining countdown time equals zero corresponding to the end of the desired time interval, all of the LED's may be flashed for a predetermined period of time to indicate the end of the desired time interval to the user, and other attention attracting signals such as alarm sounds or musical sounds, may be generated.

Alternatively, when the time interval is greater than one hour, the LED in the wedge section occupied by the hour hand may be turned on and remain on until the end of the desired time interval providing a visual indication to the user. Each time the hour hand moves into the next wedge section, the LED in that wedge section may be turned on to illuminate it and remain on until the end of the desired time interval providing another visual indication to the user. When the remaining countdown time equals zero corresponding to the end of the desired time interval, all of the LED's may be flashed for a predetermined period of time to indicate the end of the desired time interval to the user, and other attention attracting signals such as alarm sounds or musical sounds, may be generated.

The working analog clock and manipulative analog clock may be configured in a variety of shapes and sizes. For example, the clocks may be configured to be shaped as a triangle, square, octagon, or some other suitable shape, and sized to be small to be worn on a wrist, such as a wrist watch, or other part of the body, large to be viewed by a plurality of people at once, or some other suitable size. The clocks may also be manufactured from cardboard, wood, plastic, glass, metal, or other suitable materials. The clocks may be constructed for indoor and/or outdoor use.

The clocks may include an exposed face and hands or a plastic/glass encased face and hands with easy to use knobs behind the clock to allow parents or teachers to easily demonstrate different positions of the hands.

The clocks may be constructed to be free standing or wall mounted to allow for a variety of uses. The clocks may also be portable to allow the child to monitor the time on trips or for other events, and may include straps, suction cups, or other attachment devices for attaching the clock to a car seat, a child's car seat, a head rest of a front passenger or driver seat, a window, a stroller, or other item.

The working analog clocks may also include a digital clock designed within its face.

The clocks may include themes for the wedge section other than, or included with, the colors, such as designs, shapes, objects, pictures, characters, or other images. The clocks may also provide the ability for the user to insert their own pictures or images. Some of the alternative themes may include animals, sports, pirates, space, princesses, race cars, bugs, music, horses, fruits, vegetables, sea life, fairy tales, personal photos, or licensed characters, for example.

It should be understood that when words such as “about,” “approximately,” “substantially” or the like are used herein, a tolerance of plus or minus 20 percent may be employed.

While particular embodiments of the present invention have been disclosed, it is to be understood that various different embodiments are possible and are contemplated within the true spirit and scope of the appended claims. There is no intention, therefore, of limitations to the exact abstract or disclosure herein presented.

What is claimed is:

1. A method of teaching the concept of time to a user by employing an analog working clock having a group of distinctive wedge sections, a distinctive hour hand, a distinctive minute hand, and a manipulative clock similar to the working clock, comprising:
informing the user of a desired time interval;
describing at least one of the hands of the working clock in terms of its distinctive image;
describing a current location of the at least one of the hands of the working clock indicating a current wedge section as a starting time for the desired time interval;
describing the desired time interval ending location for at least one of the hands of the working clock as being an ending wedge section as an ending time for the desired time interval; and
instructing the user to move manually the at least one of the hands of the manipulative clock to a manipulative clock current segment for demonstrating a time interval current location corresponding to the current segment of the working clock;
instructing the user to move manually the at least one of the hands of the manipulative clock to an ending clock segment for demonstrating a time interval ending location corresponding to the ending segment of the working clock; and
instructing the user to observe the at least one of the hands of the working clock to determine when the at least one of the hands of the working clock indicate the working clock ending segment corresponding to the manipulative clock ending segment to signify the end of the desired time interval.

2. A method of teaching the concept of time to a child using an analog clock having a group distinctively imaged wedge sections, a distinctively imaged hour hand, a distinctively imaged minute hand, a timer device, and twelve LEDs for individually illuminating each of the wedge sections, comprising:
receiving a time interval to be taught to a child;
receiving a start signal to begin a countdown of the time interval;
turning on the LED associated with the wedge section of the current location of one of the hands;
turning on the LED associated with the adjacent wedge section when the one of the hands moves into the adjacent wedge section;
determining an end of the countdown of the time interval; and
flashing the group of LEDs for a predetermined period of time at the end of the countdown of the time interval.

3. The method of claim 2, further including determining if the time interval is greater than one hour.

4. The method of claim 3, further including waiting until the countdown has a remaining time equal to one hour.

5. The method of claim 2, wherein receiving a time interval includes receiving a signal from a timer switch.

6. The method of claim 2, wherein receiving a time interval includes receiving a signal from at least one of an up switch and a down switch.

7. The method of claim 2, wherein receiving a start signal includes receiving a signal from a timer switch.

8. The method of claim 2, wherein the one of the hands is the minute hand when the time interval is less than one hour.

9. The method of claim 2, wherein the one of the hands is the hour hand when the time interval is greater than one hour.

10. An aid for teaching the concept of time comprising:
an analog clock including an inner face portion, an outer face portion, an hour hand, and a minute hand;
the inner face portion including a group of wedge sections, each wedge section includes a distinctive indicia;
the outer face portion surrounds the inner face portion and includes clock numbers appropriately spaced around the outer face portion, each clock number includes an element related to the distinctive image of the corresponding wedge section;
the hour hand includes a first distinctive indicia;
the minute hand includes a second distinctive indicia;
a manipulative clock having an appearance substantially the same as the analog clock; and
wherein a user can set the time on the manipulative clock to correspond to a desired time interval.

11. The aid of claim 10, further including a timer device.

12. The aid of claim 11, further including a plurality of LED's with at least one LED disposed to illuminate each wedge section.

13. The aid of claim 12, wherein the timer device includes a microprocessor for controlling the LED's.

14. The aid of claim 13, wherein the timer device includes a timer switch, an up switch, and a down switch for providing inputs to the microprocessor.

15. The aid of claim 11, wherein each wedge section is a transparent piece of colored plastic.

16. The aid of claim 10, wherein the first distinctive visual appearance includes a plurality of multi-colored stripes and the second distinctive visual appearance includes a plurality of multi-colored dots.

17. The aid of claim 10, wherein the distinctive images of the wedge sections include different colors.

18. The aid of claim 10, wherein the distinctive images of the wedge sections include different designs.
